(19) United States
(12) Patent Application Publication
(10) Pub. No.: US 2022/0225587 A1
(43) Pub. Date: Jul. 21, 2022

(54) Hydroponic Growing Assembly

(71) Applicant: Scott Buchanan, Anchorage, AK (US)

(72) Inventor: Scott Buchanan, Anchorage, AK (US)

(21) Appl. No.: 17/152,221

(22) Filed: Jan. 19, 2021

(51) Int. Cl. A01G 31/06; A01G 25/16

(52) U.S. Cl. CPC A01G 31/06; A01G 25/165

(57) ABSTRACT

A hydroponic growing assembly includes a support frame and a platform is positionable on the support frame. The platform has a plurality of holes each extending therethrough. A plurality of canisters each has a plant growing in a substrate contained therein. Each of the canisters is insertable into a respective one of the holes in the platform for maintaining each of the canisters in an upright position. A tray is provided that is filled with a nutrient solution. The tray is positionable beneath the platform when the platform is positioned on the support frame. A pumping unit is coupled to the platform and the pumping unit pumps the nutrient solution in the tray into a respective one of the canisters for nourishing the plant in each of the canisters.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to growing devices and more particularly pertains to a new growing device for continually re-circulating a nutrient solution in a hydroponic system. The growing device includes a plurality of canisters that are elevated above a tray that captures the nutrient system that drains from the canisters.

### (2) Description of Related Art Including Information Disclosed Under 37 CFR 1.97 and 1.98

The prior art relates to growing devices including a variety of multi-stage hydroponic systems. The prior art discloses a hydroponic system that employs stacked cylinders. The prior art discloses an indoor growing system that includes a nutrient tray and a fluid pump for pumping a nutrient solution upwardly from the nutrient tray. In no instance is a hydroponic system that includes cylinders, a fluid tray and a fluid pump.

### BRIEF SUMMARY OF THE INVENTION

An embodiment of the disclosure meets the needs presented above by generally comprising a support frame and a platform is positionable on the support frame. The platform has a plurality of holes each extending therethrough. A plurality of canisters each has a plant growing in a substrate contained therein. Each of the canisters is insertable into a respective one of the holes in the platform for maintaining each of the canisters in an upright position. A tray is provided that is filled with a nutrient solution. the tray is positionable beneath the platform when the platform is positioned on the support frame. A pumping unit is coupled to the platform and the pumping unit pumps the nutrient solution in the tray into a respective one of the canisters for nourishing the plant in each of the canisters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a hydroponic growing assembly according to an embodiment of the disclosure.

FIG. 2 is an exploded perspective view of a support frame of an embodiment of the disclosure.

FIG. 3 is an exploded perspective view of an embodiment of the disclosure.

FIG. 4 is a perspective in-use view of a canister of an embodiment of the disclosure.

### DETAILED DESCRIPTION OF THE INVENTION

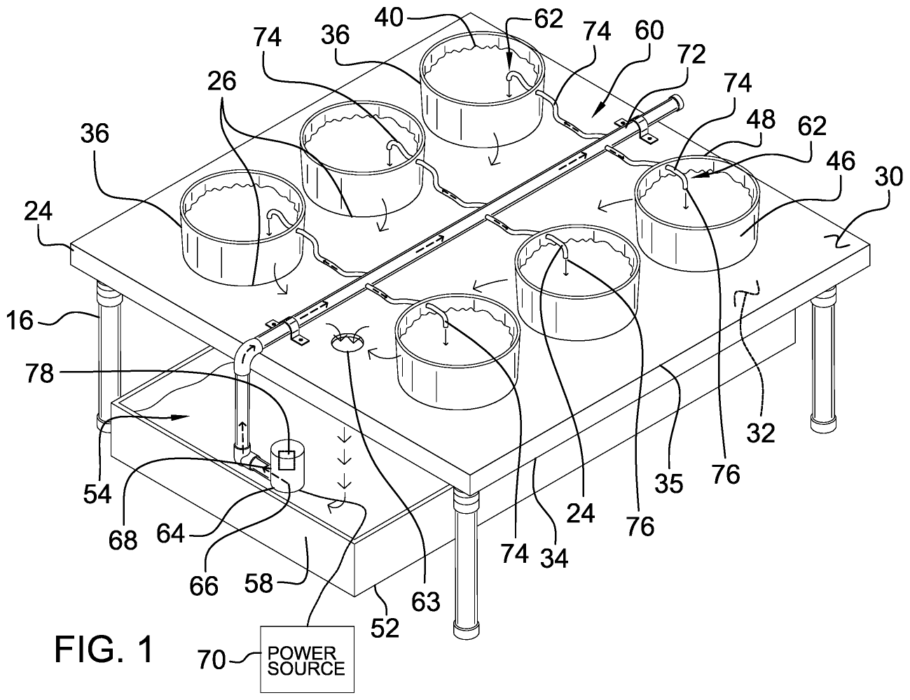

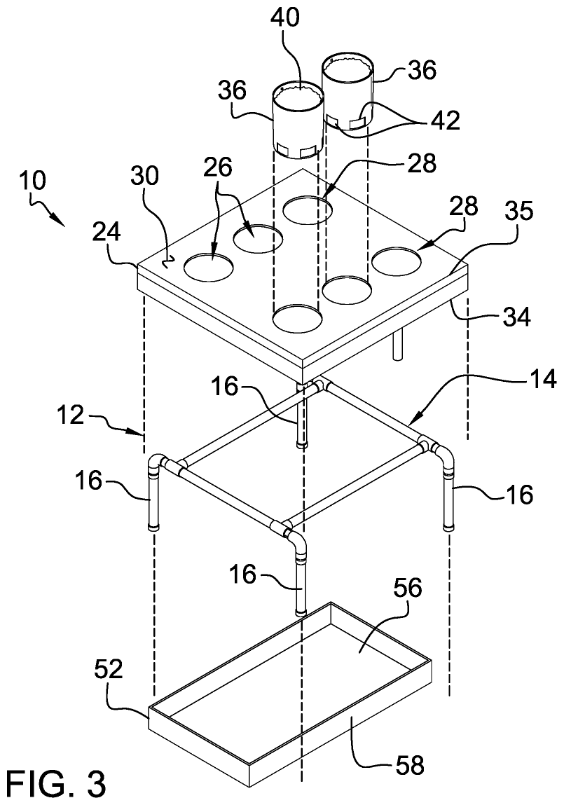

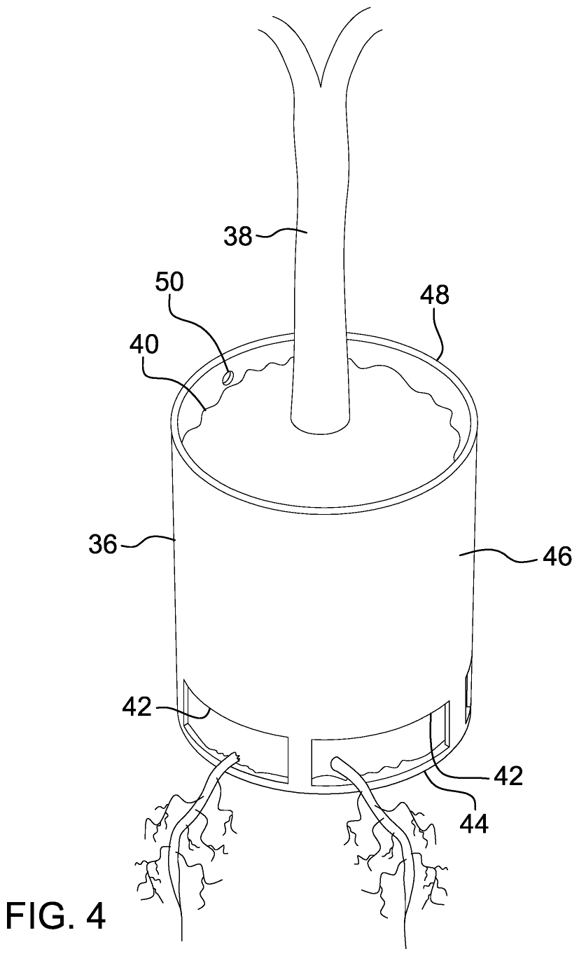

With reference now to the drawings, and in particular to FIGS. 1 through 4 thereof, a new growing device embodying the principles and concepts of an embodiment of the disclosure and generally designated by the reference numeral 10 will be described.

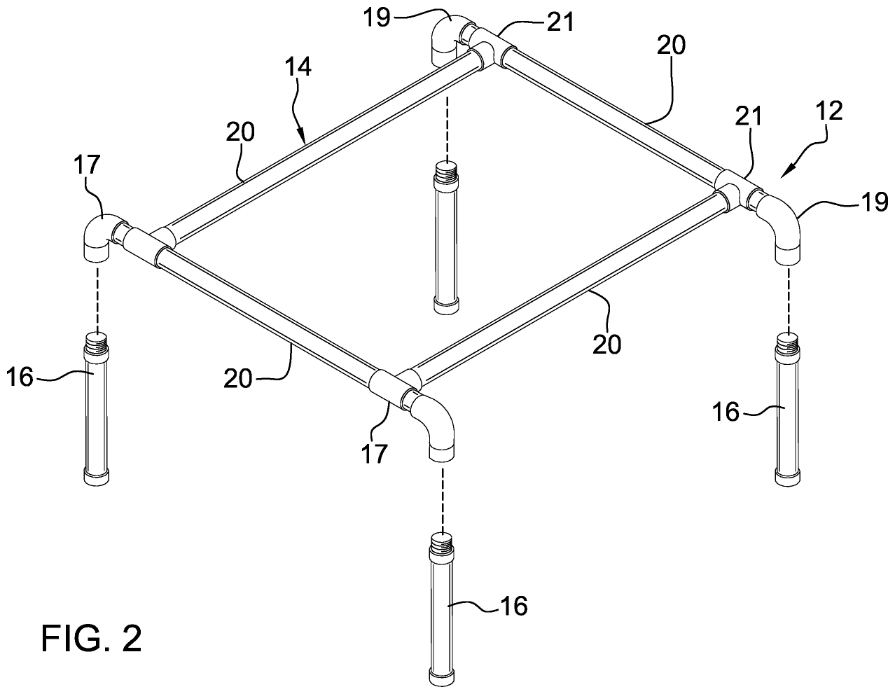

As best illustrated in FIGS. 1 through 4, the hydroponic growing assembly 10 generally comprises a support frame 12 that includes a table portion 14 and a plurality of legs 16 each extending downwardly from the table portion 14. In this way each of the legs 16 can space the table portion 14 upwardly from a support surface 18. The table portion 14 comprises a plurality of intersecting members 20 such that the table portion 14 defines a rectangle. Each of the legs 16 is aligned with a respective one of four corners 22 of the rectangle defined by the table portion 14. As is most clearly shown in FIG. 2, the support frame 12 may be comprised of a plurality of modular pieces 17, including elbows 19 and tee fittings 21, and each of the legs 16 may threadably engage a respective one of the elbows 19.

A platform 24 is included and the platform 24 is positionable on the table portion 14 of the support frame 12. The platform 24 has a plurality of holes 26 each extending therethrough and the holes 26 are arranged into a plurality of rows 28 on the platform 24. The platform 24 has a top surface 30 and a bottom surface 32, and each of the holes 26 extends through the top surface 30 and the bottom surface 32. The platform 24 has a lip 34 extending downwardly from the bottom surface 32, the lip 34 is aligned with a perimeter 35 of the platform 24 and the lip 34 is coextensive with the perimeter 35. Moreover, the bottom surface 32 of the platform 24 rests on the table portion 14 of the support frame 12 having each of the intersecting members 20 abutting the lip 34. In this way the platform 24 is inhibited from sliding on the support frame 12.

A plurality of canisters 36 is provided and each of the canisters 36 can have a plant 38 growing in a substrate 40 contained therein. The plant 38 may be a tomato plant, for example, or any other rooted plant that can be grown in soil. Additionally, the substrate 40 may be a mixture of clay beads and perlite, or any other soilless substrate that is commonly employed for hydroponic growing systems. Each of the canisters 36 has a plurality of root openings 42 extending therethrough to accommodate roots of the plant 38 in each of the canisters 36. Additionally, each of the canisters 36 is insertable into a respective one of the holes 26 in the platform 24 for maintaining each of the canisters 36 in an upright position.

Each of the canisters 36 has a bottom wall 44 and an outer wall 46 extending upwardly therefrom, and each of the root openings 42 extends through the outer wall 46 of a respective one of the canisters 36. The root openings 42 in the respective canister 36 are aligned with the bottom wall 44 of the respective canister 36, and the root openings 42 are spaced apart from each other and are distributed around the outer wall 46 of the respective canister 36. The outer wall 46 has a distal edge 48 with respect to the bottom wall 44 and the outer wall 46 flares outwardly between the bottom wall 44 and the distal edge 48. Moreover, the outer wall 46 achieves a diameter that is greater than the diameter of the holes 26 in the platform 24 such that the canisters 36 are inhibited from falling through the respective hole. Additionally, the outer wall 46 of each of the canisters 36 has a feed opening 50 extending therethrough, and the feed opening 50 is positioned adjacent to the distal edge 48 of the outer wall 46 of a respective canister 36.

A tray 52 is provided and the tray 52 can be filled with a nutrient solution 54. The nutrient solution 54 may be a mixture of fertilizer, water, nutrients or any other type of solution that is commonly employed for hydroponic plant growing. The tray 52 is positionable beneath the platform 24 when the platform 24 is positioned on the support frame 12. The tray 52 has a basal wall 56 and a perimeter wall 58 extending upwardly therefrom and the perimeter wall 58 contains the nutrient solution 54.

A pumping unit 60 is coupled to the platform 24 and the pumping unit 60 is placed in fluid communication with the tray 52 when the tray 52 is positioned beneath the platform 24. In this way the pumping unit 60 can pump the nutrient solution 54 in the tray 52. The pumping unit 60 includes a plurality of outputs 62 and each of the outputs 62 is directed into a respective one of the canisters 36 when the respective canister 36 is inserted into the respective hole 26 in the platform 24. In this way the pumping unit 60 can pump the nutrient solution 54 into the canisters 36 for nourishing the plant 38 in each of the canisters 36. The platform 24 has a drain opening 63 extending therethrough for draining nutrient solution 54 that might overflow from any of the canisters 36 back into the tray 52.

The pumping unit 60 comprises a pump 64 that has an intake 66 and an exhaust 68. The pump 64 is positionable on top of the basal wall 56 of the tray 52 such that the intake 66 is submerged in the nutrient solution 54. The pump 64 is electrically coupled to a power source 70 and the pump 64 may comprise an electric, submersible fluid pump or the like. The power source 70 may comprise a female electrical outlet or the like. The pumping unit 60 includes a distribution pipe 72 that is fluidly coupled to the exhaust 68 of the pump 64. In this way the pump 64 can pump the nutrient solution 54 into the distribution pipe 72. The distribution pipe 72 is routed to extend along the top surface 30 of the platform 24 and the distribution pipe 72 is positioned between respective rows 28 defined by the holes 26 in the platform 24. The distribution pipe 72 may include a series of bends between the platform 24 and the pump 64, and the distribution pipe 72 may be comprised of polyvinylchloride or other type of rigid material.

A plurality feed tubes 74 is each fluidly coupled to the distribution pipe 72 to receive the nutrient solution 54 pumped by the pump 64. The feed tubes 74 are spaced apart from each other and are distributed along the top surface 30 of the platform 24. Each of the feed tubes 74 extends laterally away from the distribution pipe 72 such that each of the feed tubes 74 is directed toward a respective one of the holes 26 in the platform 24. Additionally, each of the feed tubes 74 is extendable through the feed opening 50 in the outer wall 46 of a respective one of the canisters 36 such that a distal end 76 of each of the feed tubes 74 is retained within the respective canister 36. In this way each of the feed tubes 74 is oriented to direct the nutrient solution 54 into the substrate 40 contained in the respective canister 36. Moreover, the plurality of feed tubes 74 defines a respective output 62 of the pumping unit 60. Each of the feed tubes 74 may be comprised of a flexible material, such as rubber or the like, to facilitate the feed tubes 74 to be routed through the feed opening 50 in the respective canister 36.

The pumping unit 60 includes a timer circuit 78 that is coupled to the pump 64 and the timer circuit 78 is electrically coupled to the pump 64. The timer circuit 78 counts down a duration of time for a pumping cycle and a duration of time between pumping cycles. The timer circuit 78 alternately counts down the pumping cycle and the duration of time between pumping cycles. Additionally, the pump 64 is turned on when the timer circuit 78 begins counting down the pumping cycle and the pump 64 is turned off when the timer circuit 78 finishes counting down the pumping cycle. The pump 64 is continuously turned off while the timer circuit 78 counts down the duration of time between the pumping cycles and the pump 64 is turned on each time the timer circuit 78 begins counting down the pumping cycle.

In use, the platform 24 is positioned on the support frame 12, the tray 52 is filled with the nutrient solution 54 and the tray 52 is positioned beneath the support frame 12. Each of the canisters 36 is filled with the substrate 40 and the plant 38, and each of the canisters 36 is inserted into a respective one of the holes 26 in the platform 24. Each of the feed tubes 74 is extended through the feed opening 50 in the outer wall 46 of a respective one of the canisters 36. In this way the nutrient solution 54 is pumped into each of the canisters 36 each time the pump 64 is turned on. Moreover, the tray 52 captures the nutrient solution 54 that drips out of the canisters 36 to facilitate the nutrient solution 54 to be continuously re-circulated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hydroponic growing assembly for growing a plurality of plants hydroponically, said assembly comprising:
a support frame comprising a table portion and a plurality of legs each extending downwardly from said table portion wherein each of said legs is configured to space said table portion upwardly from a support surface;
a platform being positionable on said table portion of said support frame, said platform having a plurality of holes each extending therethrough, said holes being arranged into a plurality of rows on said platform;
a plurality of canisters each being configured to have a plant growing in a substrate contained therein, each of said canisters having a plurality of root openings extending therethrough wherein each of said root openings in each of said canisters is configured to accommodate roots of the plant in each of said canisters, each of said canisters being insertable into a respective one of said holes in said platform for maintaining each of said canisters in an upright position;
a tray being configured to be filled with a nutrient solution, said tray being positionable beneath said platform when said platform is positioned on said support frame; and
a pumping unit being coupled to said platform, said pumping unit being placed in fluid communication with said tray when said tray is positioned beneath said platform wherein said pumping unit is configured to pump the nutrient solution in said tray, said pumping unit including a plurality of outputs, each of said outputs being directed into a respective one of said canisters when said respective canister is inserted into said respective hole in said platform wherein said pumping unit is configured to pump the nutrient solution into said canisters for nourishing the plant in each of said canisters.

2. The assembly according to claim 1, wherein said platform has a top surface and a bottom surface, each of said holes extending through said top surface and said bottom surface, said platform having a lip extending downwardly from said bottom surface, said lip being aligned with a perimeter of said platform, said lip being coextensive with said perimeter.

3. The assembly according to claim 2, wherein:
said table portion comprises a plurality of intersecting members such that said table portion defines a rectangle, each of said legs being aligned with a respective one of four corners of said rectangle defined by said table portion; and
said bottom surface rests on said table portion of said support frame having each of said intersecting members abutting said lip thereby inhibiting said platform from sliding on said support frame.

4. The assembly according to claim 3, wherein each of said canisters has a bottom wall and an outer wall extending upwardly therefrom, each of said root openings extending through said outer wall of a respective one of said canisters, said root openings on said respective canister being aligned with said bottom wall of said respective canister, said root openings being spaced apart from each other and being distributed around said outer wall of said respective canister.

5. The assembly according to claim 4, wherein said outer wall has a distal edge with respect to said bottom wall, said outer wall flaring outwardly between said bottom wall and said distal edge such that said outer wall achieves a diameter being greater than the diameter of said holes in said platform such that said canisters are inhibited from falling through said respective hole.

6. The assembly according to claim 4, wherein said outer wall of each of said canisters has a feed opening extending therethrough, said feed opening being positioned adjacent to said distal edge of said outer wall of a respective canister.

7. The assembly according to claim 1, wherein:
said tray has a basal wall and a perimeter wall extending upwardly therefrom wherein said perimeter wall is configured to contain the nutrient solution; and
said pumping unit comprises a pump having an intake and an exhaust, said pump being positionable on top of said basal wall of said tray wherein said intake is configured to be submerged in the nutrient solution, said pump being electrically coupled to a power source.

8. The assembly according to claim 7, wherein said pumping unit includes a distribution pipe being fluidly coupled to said exhaust of said pump wherein said pump is configured to pump the nutrient solution into said distribution pipe, said distribution pipe being routed to extend along said top surface of said platform, said distribution pipe being positioned between respective rows defined by said holes in said platform.

9. The assembly according to claim 8, wherein said pumping unit includes a plurality feed tubes, each of said feed tubes being fluidly coupled to said distribution pipe wherein each of said feed tubes is configured to receive the nutrient solution pumped by said pump, said feed tubes being spaced apart from each other and being distributed along said top surface of said platform, each of said feed tubes extending laterally away from said distribution pipe such that each of said feed tubes is directed toward a respective one of said holes in said platform, each of said feed tubes defining a respective one of said outputs of said pumping unit.

10. The assembly according to claim 9, wherein:
each of said canisters has an outer wall, said outer wall having a distal edge, said outer wall of each of said canisters having a feed opening extending therethrough, said feed opening being positioned adjacent to said distal edge of said outer wall of a respective canister; and
each of said feed tubes is extendable through said feed opening in said outer wall of a respective one of said canisters such that a distal end of each of said feed tubes is retained within said respective canister wherein each of said feed tubes is configured to direct the nutrient solution into the substrate contained in said respective canister.

11. The assembly according to claim 7, wherein said pumping unit includes a timer circuit being coupled to said pump, said timer circuit being electrically coupled to said pump, said timer circuit counting down a duration of time for a pumping cycle and a duration of time between pumping cycles, said timer circuit alternately counting down said pumping cycle and said duration of time between pumping cycles.

12. The assembly according to claim 11, wherein said pump is turned on when said timer circuit begins counting down said pumping cycle, said pump being turned off when said timer circuit finishes counting down said pumping cycle, said pump being continuously turned off while said timer circuit counts down said duration of time between said pumping cycles, said pump being turned on each time said timer circuit begins counting down said pumping cycle.

13. A hydroponic growing assembly for growing a plurality of plants hydroponically, said assembly comprising:
a support frame comprising a table portion and a plurality of legs each extending downwardly from said table portion wherein each of said legs is configured to space said table portion upwardly from a support surface, said table portion comprising a plurality of intersecting members such that said table portion defines a rectangle, each of said legs being aligned with a respective one of four corners of said rectangle defined by said table portion;
a platform being positionable on said table portion of said support frame, said platform having a plurality of holes each extending therethrough, said holes being arranged into a plurality of rows on said platform, said platform having a top surface and a bottom surface, each of said holes extending through said top surface and said bottom surface, said platform having a lip extending downwardly from said bottom surface, said lip being aligned with a perimeter of said platform, said lip being coextensive with said perimeter, said bottom surface resting on said table portion of said support frame having each of said intersecting members abutting said lip thereby inhibiting said platform from sliding on said support frame;
a plurality of canisters each being configured to have a plant growing in a substrate contained therein, each of said canisters having a plurality of root openings extending therethrough wherein each of said root openings in each of said canisters is configured to accommodate roots of the plant in each of said canisters, each of said canisters being insertable into a respective one of said holes in said platform for maintaining each of said canisters in an upright position, each of said canisters having a bottom wall and an outer wall extending upwardly therefrom, each of said root openings extending through said outer wall of a respective one of said canisters, said root openings on said respective canister being aligned with said bottom wall of said respective canister, said root openings being spaced apart from each other and being distributed around said outer wall of said respective canister, said outer wall having a distal edge with respect to said bottom wall, said outer wall flaring outwardly between said bottom wall and said distal edge such that said outer wall achieves a diameter being greater than the diameter of said holes in said platform such that said canisters are inhibited from falling through said respective hole, said outer wall of each of said canisters having a feed opening extending therethrough, said feed opening being positioned adjacent to said distal edge of said outer wall of a respective canister;
a tray being configured to be filled with a nutrient solution, said tray being positionable beneath said platform when said platform is positioned on said support frame, said tray having a basal wall and a perimeter wall extending upwardly therefrom wherein said perimeter wall is configured to contain the nutrient solution; and
a pumping unit being coupled to said platform, said pumping unit being placed in fluid communication with said tray when said tray is positioned beneath said platform wherein said pumping unit is configured to pump the nutrient solution in said tray, said pumping unit including a plurality of outputs, each of said outputs being directed into a respective one of said canisters when said respective canister is inserted into said respective hole in said platform wherein said pumping unit is configured to pump the nutrient solution into said canisters for nourishing the plant in each of said canisters, said pumping unit comprising:
a pump having an intake and an exhaust, said pump being positionable on top of said basal wall of said tray wherein said intake is configured to be submerged in the nutrient solution, said pump being electrically coupled to a power source;
a distribution pipe being fluidly coupled to said exhaust of said pump wherein said pump is configured to pump the nutrient solution into said distribution pipe, said distribution pipe being routed to extend along said top surface of said platform, said distribution pipe being positioned between respective rows defined by said holes in said platform; and
a plurality feed tubes, each of said feed tubes being fluidly coupled to said distribution pipe wherein each of said feed tubes is configured to receive the nutrient solution pumped by said pump, said feed tubes being spaced apart from each other and being distributed along said top surface of said platform, each of said feed tubes extending laterally away from said distribution pipe such that each of said feed tubes is directed toward a respective one of said holes in said platform, each of said feed tubes defining a respective one of said outputs of said pumping unit, each of said feed tubes being extendable through said feed opening in said outer wall of a respective one of said canisters such that a distal end of each of said feed tubes is retained within said respective canister wherein each of said feed tubes is configured to direct the nutrient solution into the substrate contained in said respective canister; and
a timer circuit being coupled to said pump, said timer circuit being electrically coupled to said pump, said timer circuit counting down a duration of time for a pumping cycle and a duration of time between pumping cycles, said timer circuit alternately counting down said pumping cycle and said duration of time between pumping cycles, said pump being turned on when said timer circuit begins counting down said pumping cycle, said pump being turned off when said timer circuit finishes counting down said pumping cycle, said pump being continuously turned off while said timer circuit counts down said duration of time between said pumping cycles, said pump being turned on each time said timer circuit begins counting down said pumping cycle.
